(19) United States
(12) Patent Application Publication
(10) Pub. No.: US 2011/0246327 A1
(43) Pub. Date: Oct. 6, 2011

(54) PERSONALIZED GOODS ASSEMBLY TRANSACTION SYSTEN

(76) Inventor: CHIEN-HUA WEI, Taipei (TW)

(21) Appl. No.: 12/749,518

(22) Filed: Mar. 30, 2010

(51) Int. Cl. G06Q 30/00; G06F 17/30

(52) U.S. Cl. 705/27.1; 707/802; 707/E17.044; 705/26.5

(57) ABSTRACT

A personalized goods assembly transaction system comprise a server including a first section as a consumer database; the consumer database having three sub-sections, which are a consumer data unit, a consumer goods set unit and a consumer connection unit; at least one consumer unit connected to the server through a consumer interface; wherein the consumer data unit of the consumer database serves to record the data of a consumer; the consumer goods set unit of the consumer database serves to record the goods set by the consumer; the goods set includes a list of at least one set of goods which is inputted by the consumer. The system further comprises a seller database in the memory having three sub-sections, which are a seller data unit, a seller goods menu and a seller setting unit; at least one seller unit; the seller unit being connected to the server through a seller interface.

### FIELD OF THE INVENTION

The present invention relates to goods transactions, and especially to a personalized goods assembly transaction system, in that a user only needs to point the goods set in the consumer goods set unit to a desired seller or only point an item in the consumer connection unit without the designate the goods one by one. Thus it is convenient for the consumer, while the sellers also feel easy since they only need to prepare the goods from the goods set list. The seller needs not to record the goods one by one and thus the time is shortened and cost in labors is saved.

### BACKGROUND OF THE INVENTION

Network business has become a novel and popular transaction way currently. People habitually buy goods through networks. There are many forms of network business having been developed, such as B to B (business to business) and B to C (business to consumer), auctions, etc. However, on all these transactions forms, the sellers provide the goods list to the consumers and then each time, the consumer select the desired goods from the goods list one by one.

Also, the sellers can provide an assembly of goods to the consumers. This selling form is frequently seen in the fastfood selling, for example, a fast food restaurant provides an assembly of two fried chickens, potatoes chips, pickles, a cup of black tea (less sugar and no ice bricks); and an assembly of a hamburger, potatoes chips, a cup of milk. However, the consumer accepts this way in force. If a consumer desires to have an assembly of goods matching to his (or her) willing, the consumer must point these goods one by one. This is tedious to the sellers and consumers.

Therefore, there is an eager demand for a novel design which can resolve the prior art defects and provides a mechanism which cause the consumers to have the desired goods combinations and uses these combinations in transaction directly.

### SUMMARY OF THE INVENTION

The object of the present invention is to provides a personalized goods assembly transaction system, wherein the user only needs to point the goods set in the consumer goods set unit to a desired seller or only point an item in the consumer connection unit without the designate the goods one by one. Thus it is convenient for the consumer, while the sellers also feel easy since they only need to prepare the goods from the goods set list. The seller needs not to record the goods one by one and thus the time is shortened and cost in labors is saved.

To achieve above object, the present invention provides a personalized goods assembly transaction system, comprising: a server including a processor, a memory, related communication interfaces and others; the memory of the server including a first section as a consumer database; the consumer database having three sub-sections, which are a consumer data unit, a consumer goods set unit and a consumer connection unit; at least one consumer unit connected to the server through a consumer interface; a consumer can connect to the server by using the consumer unit through the consumer interface; and wherein the consumer data unit of the consumer database serves to record the data of a consumer; the consumer goods set unit of the consumer database serves to record the goods set by the consumer; the goods set includes a list of at least one set of goods which is inputted by the consumer; the consumer connection unit of the consumer database serves to build the connections between the consumer goods sets and sellers; and wherein the consumer can select the desire goods set to a desired seller for transaction.

Furthermore, the personalized goods assembly transaction system further comprises a seller database in the memory having three sub-sections, which are a seller data unit, a seller goods menu and a seller setting unit; at least one seller unit; the seller unit being connected to the server through a seller interface; wherein the seller data unit of the seller database serves to record basic data of the seller; the seller goods menu of the seller database serves to record goods, prices, introduction of the goods for seller through the seller unit; the seller setting unit of the seller database serves to record the data about the selling of goods; and an agency interface; the agency interface serving to communicate the consumer interface and the seller interface so as to transfer the information therebetween and as a result to complete a business transaction.

The various objects and advantages of the present invention will be more readily understood from the following detailed description when read in conjunction with the appended drawing.

### BRIEF DESCRIPTION OF THE DRAWINGS

FIG. 1 shows the hardware structure of the present invention.

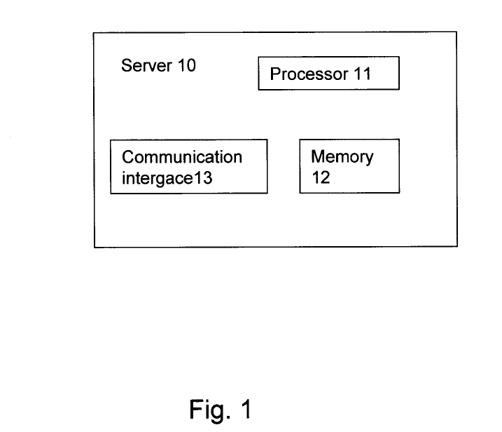

FIG. 2 shows the whole system of the present invention.

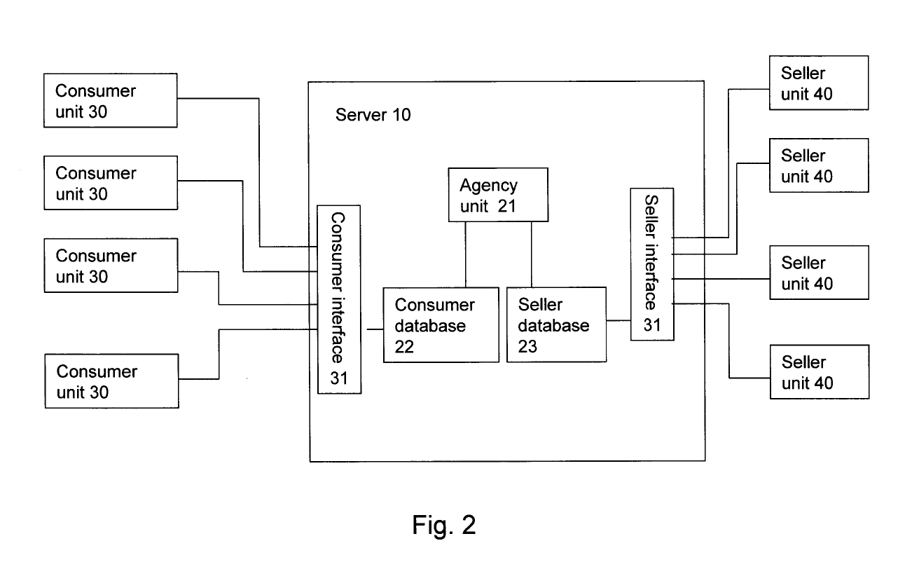

FIG. 3 shows the structure of the consumer database of the present invention.

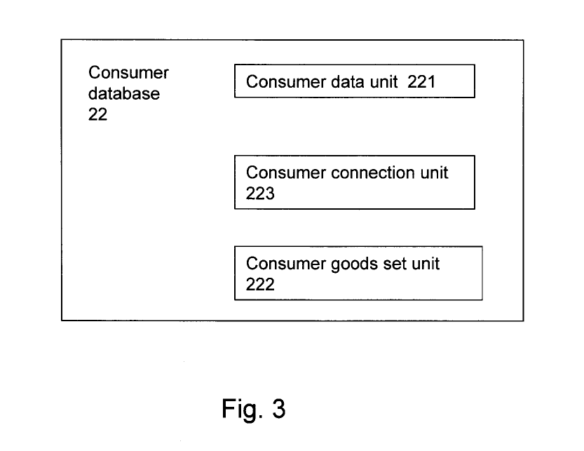

FIG. 4 shows the structure of the seller database of the present invention.

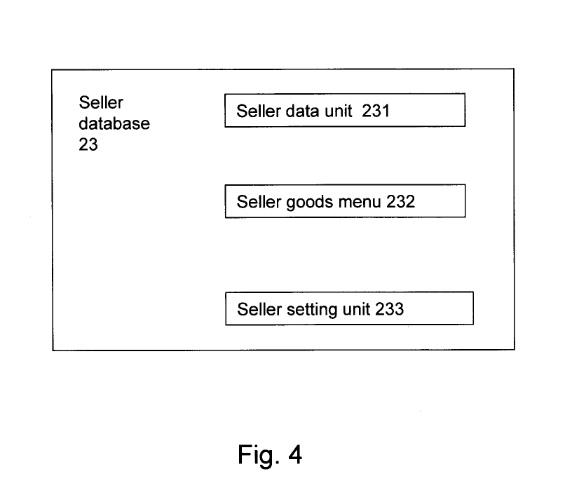

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

The hardware structure of the present invention will be described herein.

A server 10 includes a processor 11, a memory 12, related communication interfaces 13 and others. The memory 12 of the server 10 includes a first section as a consumer database 22 and a second section as a seller database 23. The consumer database 22 has three sub-sections, which are a consumer data unit 221, a consumer goods set unit 222 and a consumer connection unit 223. The seller database 23 has three sub-sections, which are a seller data unit 231, a seller goods menu 232 and a seller setting unit 233.

At least one seller unit 40 may be a computer, a handset, a PDA (personal digital assistance), or other electronic input devices or the combination thereof. The seller unit 40 is connected to the server 10 through a seller interface 41. For the seller unit 40, the seller data unit 231 of the seller database 23 serves to record names, addresses, telephone numbers, etc of the seller through the seller unit 40. The seller goods menu 232 of the seller database 23 serves to record goods, prices, introduction of the goods, etc. for seller through the seller unit 40. for example, the fast food restaurant may record the data about burgers, potatoes chips, juices, fried chickens, etc. The clothing store may have the record about the clothe, trousers, etc. The seller setting unit 233 of the seller database 23 serves to record the data about the selling of goods, such as payment conditions (for example, by cashing, by checks, or by credit cards, etc.), sending condition (such as sending before payment, or sending after payment).

At least one consumer unit 30 may be one of a computer, a handset, a PDA, etc., which is connected to the server 10 through a consumer interface 31. The server 10 provides the consumer with the following functions.
(1) The consumer data unit 221 of the consumer database 22 serves to record the data of a consumer, such as names, address, ages, ID numbers, etc. of the consumer.
(2) The consumer goods set unit 222 of the consumer database 22 serves to record the assembles of goods set by the consumer, for example,
a consumer fastfood A: two fried chickens (only legs); potatoes chips, pickles, a cup of black tea (less sugar and no ice bricks);
a consumer fastfood B: a hamburger, potatoes chips, a cup of milk (without sugar);
a consumer pizza cambo A: A Thailand pizza, a fruit pizza, four fried chicken legs, and a can of cola;
a consumer Chinese cambo A: a bowl of rice, a fried pork chop, potatoes chips, a cabbage, a sweet corn soup, a cup of lemon juicy; and
a consumer reservation condition: 7 o'clock at night; near a window, two persons; and a candle at the table.
(3) The consumer connection unit 223 of the consumer database 22 serves to build the connections between the consumer goods sets and the seller, for example,
the consumer fastfood A is connected to McDonald;
the consumer fastfood B is connected to KFC;
the consumer pizza cambo is connected to PIZZA hut;
the consumer Chinese cambo A is connected to Haytt; and
the consumer reservation condition: is connected to Haytt.

By the present invention, the consumer can select the desire goods and then combine these goods as a set with desired conditions, and then these goods set can be set to the desired seller as listed in the consumer connection unit 223; however, the consumer can point the goods set to a desired seller not listed in the consumer connection unit 223.

An agency interface 21 is in the server 10 which is the combination of the processor 11, the memory 12 and the communication interface 13. The agency interface 21 serves to communicate the consumer interface 31 and the seller interface 41 so as to transfer the information therebetween and as a result to complete a business transaction.

The application of the present invention will be described herein. Firstly, the seller enters into the server 10 through the seller database 23, such as a computer, a handset, or a PDA. Then the seller records the basic data of the seller on the seller data unit 231 of the seller database 23; and record the information about the goods of the seller on the seller goods menu 232 of the seller database 23; and record the conditions of selling on the seller setting unit 233 of the seller database 23. The consumer enters into the server 10 from the consumer database 22 through the consumer interface 31. Then the consumer record the data of the consumer on the consumer data unit of the consumer database; and record the assemblies of goods on the consumer data unit 221 of the consumer database 22; and as desired the consumers can built the connections between the goods set and the sellers in the consumer connection unit 223 of the consumer database 22. These information can be communicated through the agency interface 21 in the server 10.

If a consumer desires to buy the goods set, the consumer can simply select the connection on the consumer connection unit 223 of the consumer database 22. However, if the connection in the consumer connection unit 223 of the consumer database 22 has no item which is matched to the need of the consumer, the consumer can directly point the goods set in the consumer goods set unit 222 of the seller database 23 to a desired seller through the agency interface 21.

Advantages of the present invention are that the user only needs to point the goods set in the consumer goods set unit 222 to a desired seller or only point an item in the consumer connection unit 223 without the designate the goods one by one. Thus it is convenient for the consumer, while the sellers also feel easy since they only need to prepare the goods from the goods set list. The seller needs not to record the goods one by one and thus the time is shortened and cost in labors is saved.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A personalized goods assembly transaction system, comprising:
a server including a processor, a memory, related communication interfaces and others; the memory of the server including a first section as a consumer database; the consumer database having three sub-sections, which are a consumer data unit, a consumer goods set unit and a consumer connection unit;
at least one consumer unit connected to the server through a consumer interface; a consumer can connect to the server by using the consumer unit through the consumer interface; and
wherein the consumer data unit of the consumer database serves to record the data of a consumer; the consumer goods set unit of the consumer database serves to record the goods set by the consumer; the goods set includes a list of at least one set of goods which is inputted by the consumer; and
wherein the consumer can select the desire goods set to a desired seller for transaction.

2. The personalized goods assembly transaction system as claimed in claim 1, further comprising:
a seller database in the memory having three sub-sections, which are a seller data unit, a seller goods menu and a seller setting unit;
at least one seller unit; the seller unit being connected to the server through a seller interface; wherein the seller data unit of the seller database serves to record basic data of the seller; the seller goods menu of the seller database serves to record goods, prices, introduction of the goods for seller through the seller unit; the seller setting unit of the seller database serves to record the data about the selling of goods; and
an agency interface; the agency interface serving to communicate the consumer interface and the seller interface so as to transfer the information therebetween and as a result to complete a business transaction.

3. The personalized goods assembly transaction system as claimed in claim 1, further comprising:
a consumer connection unit which lists connections between goods sets in the consumer goods set unit and the sellers.

4. The personalized goods assembly transaction system as claimed in claim 1, wherein the seller unit is selected from computer, handsets, and PDAs.

5. The personalized goods assembly transaction system as claimed in claim 1, wherein the consumer unit is selected from computer, handsets, PDAs.
